(19) United States
(12) Patent Application Publication
(10) Pub. No.: US 2014/0322352 A1
(43) Pub. Date: Oct. 30, 2014

(54) Antimicrobial Composition for Animal Welfare

(71) Applicant: CMS Innovative Technologies, Inc., Danbury, CT (US)

(72) Inventors: David H. Creasey, Splendora, TX (US); Jerry B. Creasey, Conroe, TX (US)

(21) Appl. No.: 14/366,737

(22) PCT Filed: Dec. 20, 2012
(86) PCT No.: PCT/US12/70864

§ 371 Date: Jun. 19, 2014

Related U.S. Application Data
(60) Provisional application No. 61/579,283, filed on Dec. 22, 2011.

(51) Int. Cl. A01N 59/20

(52) U.S. Cl. CPC A01N 59/20
USPC 424/618; 422/28; 422/5

(57) ABSTRACT

An antimicrobial solution for disinfecting or removing micro-organisms from a surface used by animals or for use as an animal shampoo is described. The solution is active against bacteria, fungi, and viruses, including enveloped viruses, and skin disorders related to insect infestation.

### RELATED APPLICATIONS

This application claims priority to U.S. Provisional Application No. 61/579,283, which was filed on Dec. 22, 2011, and is incorporated by reference in its entirety for all purposes.

### FIELD OF THE INVENTION

The invention relates generally to an aqueous antimicrobial solution for animals and animal cages, pens, treatment surfaces and supplies.

### BACKGROUND OF THE INVENTION

Disinfection of animal care facilities is critical for controlling microorganisms causing disease and infection and for promoting animal welfare. Currently the types of disinfectants used by animal care facilities are solutions of sodium hypochlorite (bleach) or quaternary ammonium compounds. However, bleach solutions are undesirable because they are corrosive, leading to the deterioration of metal fixtures, and can cause respiratory distress to animals. Quaternary ammonium solutions are less effective disinfectants than bleach, but are not corrosive. However, quaternary ammonium compounds are ineffective against non-enveloped viruses, such as parvo virus (Shelter Medicine for Vets and Staff, Miller and Zawistowski, Eds., Blackwell Publ., 2004, pp. 76-77). In addition, quaternary ammonium disinfectants have been shown to adversely affect reproduction and survival of newborns in laboratory animal facilities (Hunt, Biol. Reprod. 78: 232, Abstract 757, 2008).

Accordingly, there is a need for an effective, noncorrosive antimicrobial disinfectant having no adverse side effects for use in animal care facilities and products.

### SUMMARY OF THE INVENTION

An aqueous antimicrobial composition comprising an acid selected from the group consisting of sulfuric acid, phosphoric acid, fumaric acid, and acetic acid; an ammonium compound or sodium sulfate; two metal sulfates selected from the group consisting of sodium sulfate, silver sulfate, copper sulfate, magnesium sulfate, manganese sulfate, and zinc sulfate; and a surfactant, wherein the composition is not corrosive and is not an irritant is presented. An animal shampoo comprising a dilution of this composition is also presented.

Methods for preparing the antimicrobial composition are presented. An embodiment of these methods comprises the steps of a) adding a selected amount of each of silver sulfate, copper sulfate, clear ammonium sulfate or clear sodium sulfate solution, and sodium lauryl sulfate to a selected volume of water to form a solution; b) mixing and heating the solution to 130°-140° F.; and c) adding a selected amount of glycerin to the solution.

Methods for using the antimicrobial composition as a disinfectant, an animal shampoo, a deodorant, to remove micro-organisms and insects, and as a treatment for skin disorders are presented. These methods comprise the steps of diluting the composition; applying the dilute solution to the surface or animal to be treated; and rinsing the dilute solution away from the treated surface or animal.

### DETAILED DESCRIPTION OF THE INVENTION

An antimicrobial composition is presented that is effective against bacterial, viral and fungal organisms, but is not corrosive or harmful to animals. The solution may be used for cleaning surfaces such as cages, pens, animal carriers, examining tables, and animal supplies, such as food and water containers, pet toys, etc. The antimicrobial solution is easy to use and is also effective at removing odors associated with animals and animal care. The composition may include an acid, an ammonium compound, an anionic or nonionic surfactant, and at least two metal sulfates selected from the group consisting of copper, silver, magnesium, and manganese or may contain sodium sulfate instead of an ammonium compound.

A preferred concentrate of the antimicrobial solution is prepared by combining the ingredients as listed in Table 1, mixing and heating the mixture to 130°-140° F., then adding from 15 to 50 g, preferably 22 g, of glycerin and allowing the mixture to cool.

TABLE 1
Concentrated antimicrobial solution

| Ingredient | Amount | |
|---|---|---|
| Distilled water | 1 | L |
| Silver sulfate | 1.6 | g |
| Copper sulfate | 64.3 | g |
| Clear ammonium compound | 30.5 | g |
| or Clear sodium sulfate | | |
| solution | | |
| Sodium lauryl sulfate | 50.0 | g |

The silver sulfate compound is preferably at least 98% pure. Silver nitrate may be substituted for silver sulfate. The concentrations of ingredients may be varied as needed. Up to 74 g of copper sulfate may be added. Sodium lauryl sulfate may be used at concentrations ranging from 5 to 100 g/L. Silver sulfate or silver nitrate may be added at 0.2-8 g/L, preferably 1-2 g/L. Sodium acid pyrophosphate (SAPP) may be added at 4 to 6% if desired. Other surfactants and detergents may be added. The concentrated antimicrobial solution may be stored in plastic or glass containers at room temperature.

The clear ammonium compound solution or clear sodium sulfate solution is prepared by placing a low pH acid, such as sulfuric, phosphoric, fumaric, acetic, or stabilized hydrochloric acid, at a predetermined quantity in a vessel. Acid concentration in the Clear solution can range from 25-40%, preferably, 30-32% Exemplary embodiments of the clear solution are described in U.S. Pat. No. 8,012,511 and US 2012/0027869, which are incorporated herein by reference. Preferably, the acid is of very high purity, i.e., between approximately 98 percent to approximately 99.9 percent purity. Water is placed in a separate vessel and heated to 140° F. The water is preferably distilled, filtered, deionized, pharmaceutical or medical grade water. When the water reaches 140° F., a selected amount of an ammonium compound or sodium sulfate is added to the water. The ammonium compound or sodium sulfate may be added to a concentration of 5-15%, preferably 8-9%. The preferred ammonium compound is ammonium sulfate. Other ammonium compounds, such as anhydrous ammonium and ammonium nitrate may be used. Any effective means can be used to dissolve the ammonium compound or sodium sulfate in the water, e.g., air injection or a mechanical mixer can be employed.

The acid and the ammonium compound or sodium sulfate solution are then simultaneously injected by spraying, (e.g., via spargers), into a large (e.g., 400 gallon) stainless steel vessel maintained at from 1 to 20 psi, preferably 2-7 psi, and mixed. DC current, 1-3 amps, is passed through the mixture as it is filled into the pressure vessel and during the subsequent heating step. The mixture is heated to a temperature not exceeding about 1200° F., and is maintained at the final temperature for 3-4 hours while excess hydrogen gas is removed. A cooling jacket is required to keep the temperature below approximately 1200° F. Following this heating step, the mixture is allowed to cool to room temperature. The cooled mixture is stabilized by adding a portion of the original acid plus ammonium or sodium sulfate solution that has not been exposed to high temperature to 10% v/v. Heat, pressure and the addition of stabilizer neutralize free radicals in the solution, resulting in a final solution, designated “Clear”, that is not corrosive and is not an irritant.

The reaction of acid, water and ammonium or sodium sulfate compound is exothermic and the time and temperature of the reaction will vary based on the amount of reactants, size of reactor and reactivity of selected reactants. The temperature of the mixture is preferably maintained in a range between approximately 250° F. and approximately 1200° F., more preferably at approximately 300° F.-800b° F. The reaction time varies between 60 minutes and 16 hours, preferably between 3 and 8 hours, more preferably between approximately 3 to 4 hours when reactants are preheated. Preheating is recommended for smaller volumes of reactants, i.e., between approximately 400-1000 gallons, so that the reaction temperature is reached quickly and can be maintained for a shorter period of time, such as 1-4 hours. For example, ammonium sulfate can be preheated so that it stabilizes at about 160° F., and sulfuric acid can be preheated to about 125° F. before mixing with the ammonium sulfate.

The concentrated antimicrobial solution is preferably diluted prior to use. The concentrated solution is mixed, e.g., by shaking, before diluting. For cleaning and disinfecting surfaces, the solution is diluted at from 2 to 10 ounces per gallon of water, preferably 2 to 5 ounces per gallon, more preferably 2 ounces per gallon. The solution can be applied to the surface to be cleaned by pouring or spraying and can be spread by any effective means such as a cloth, brush, broom, mop, sponge, etc. The solution is applied to a surface, spread, and the surface is then rinsed with water. It can be beneficial to scrub the surface or allow the solution to stand for a few minutes before rinsing. The antimicrobial solution can be used on most natural and man-made surfaces including, but not limited to, metal, plastic, glass, concrete, fabric, carpet, rubber, vinyl, polymeric, stone and wood surfaces. Surfaces may be used immediately after rinsing. The solution is not an irritant for animals, therefore, cages and pens may safely be cleaned while housing animals.

The antimicrobial solution is effective against bacteria, fungi, and viruses, including enveloped viruses, such as parvovirus, and paramyxovirus, which causes distemper. It is particularly suitable for animal facilities such as animal shelters, kennels, zoos, laboratory animal facilities, veterinary clinics, animal hospitals, dairies, ranches, farms, etc., and can also be used in the home to remove pet odors and disinfect surfaces used by pets.

The solution can be safely used as a shampoo for most animals, e.g., mammals, reptiles, and birds, to clean and disinfect the animals themselves and to treat or prevent skin conditions caused by microbial organisms and insects. For example, the solution is effective against mange, fungal infections and dermatitis, and relieves itching caused by fleas or other insects. When used as a shampoo, the concentrate is preferably diluted to 0.5 to 2 ounces per gallon of water. After applying the shampoo to the animal, the solution is lathered and then rinsed away. The solution may be left on the animal for up to 10 minutes before rinsing. After rinsing, the animal may be dried or allowed to air dry.

### EXAMPLES

1. Preparation of Concentrated Antimicrobial Solution

The antimicrobial soap concentrate was prepared as described above by adding the ingredients according to Table 2 to one liter of water. The clear sodium sulfate solution of Table 2 contained about 9% sodium sulfate and 31% sulfuric acid and was mixed by introducing pressurized air through the bottom of the vessel, perpendicular to the liquid mixer to force the liquid mixture to dynamically rotate within the pressure vessel. The antimicrobial solution ingredients were mixed gently and heated to 130° F. for about 2 minutes. After heating, 22 g of glycerin was immediately added. The solution was mixed gently by stirring. The final volume of the concentrate was 1.028 L. The concentrate was stored in a plastic (polyethylene terephthalate) bottle at room temperature.

TABLE 2
Ingredients for Antimicrobial Concentrate

| Weight in grams | Ingredient |
|---|---|
| 1.6 | Silver sulfate |
| 64.3 | Copper sulfate pentahydrate |
| 30.5 | Clear sodium sulfate solution |
| 50.0 | Sodium lauryl sulfate |

2. Antimicrobial Shampoo

The concentrated soap solution is diluted to between about 0.5 to 2 ounces of concentrate per gallon of water. The dilute solution is then used as a shampoo on an animal by applying and lathering and then rinsing off with water. The animal is then dried or allowed to air dry.

The shampoo was shown to reduce mites on dogs when used weekly. The shampoo was also used to treat an adult dog having almost complete fur loss caused by mange. The dog was washed daily with the antimicrobial shampoo diluted to about 2 ounces per gallon of water. After two weeks of shampoo treatment, the area of mange coverage was markedly reduced and fur had begun to grow over the previously affected areas.

3. Cleaning Kennels with the Antimicrobial Solution

The antimicrobial solution was tested by the City of Conroe Animal Shelter in Conroe, Tex. The concentrated soap solution was diluted to 5 ounces of concentrate per gallon of water. The diluted soap solution was applied by spraying to fifty dog and cat kennels used for “new arrival” animals at the shelter. Kennels were of various sizes depending on the animals housed. The solution was allowed to stand for about 5 minutes and then removed by rinsing with water. In general, kennels were allowed to dry for at least one minute before housing dogs and cats. In some cases, kennels were cleaned while animals remained in the kennels.

The shelter tested the product for four months and reported that it was effective in sanitizing and disinfecting the new arrival kennels, reducing pet odors, and maintaining healthy animals in the shelter.

1. An aqueous antimicrobial composition comprising an acid selected from the group consisting of sulfuric acid, phosphoric acid, fumaric acid, and acetic acid; an ammonium compound or sodium sulfate; two metal sulfates selected from the group consisting of sodium sulfate, silver sulfate, copper sulfate, magnesium sulfate, manganese sulfate, and zinc sulfate; and a surfactant, wherein the composition is not corrosive and is not an irritant.

2. The composition of claim 1, wherein the surfactant is an anionic or nonionic surfactant.

3. The composition of claim 1, wherein the surfactant is sodium lauryl sulfate.

4. The composition of claim 1, wherein the ammonium compound is selected from the group consisting of ammonium sulfate, ammonium nitrate, and anhydrous ammonium.

5. The composition of claim 1, further comprising glycerin.

6. The aqueous antimicrobial composition of claim 1, wherein the composition comprises silver sulfate, copper sulfate, a clear ammonium compound solution or clear sodium sulfate solution, sodium lauryl sulfate, and glycerin, wherein the composition is not corrosive and is not an irritant.

7. The aqueous antimicrobial composition of claim 6, wherein the concentration of silver sulfate is 0.2-8 g/L, the concentration of copper sulfate is 60-74 g/L, the concentration of clear ammonium or sodium sulfate solution is 25-35 g/L, and the concentration of sodium lauryl sulfate is 5-100 g/L.

8. The aqueous antimicrobial composition of claim 7, wherein the concentration of silver sulfate is 1-2 g/L, the concentration of copper sulfate is 60-65 g/L, the concentration of clear ammonium or sodium sulfate solution is 28-32 g/L, and the concentration of sodium lauryl sulfate is 45-55 g/L.

9. A diluted solution of the antimicrobial composition of claim 1 comprising 2-10 ounces of the composition of claim 1 per gallon of water.

10. A diluted solution of the antimicrobial composition of claim 1 comprising 0.5-2 ounces of the composition of claim 1 per gallon of water.

11. A process for preparing the antimicrobial composition of claim 6 comprising the steps of
a) adding a selected amount of each of silver sulfate, copper sulfate, clear ammonium sulfate or clear sodium sulfate solution, and the sodium lauryl sulfate to a selected volume of water to form a solution;
b) mixing and heating the solution to at least 130° F.; and
c) adding a selected amount of glycerin to the solution.

12. A method for disinfecting a surface used in animal care comprising the steps of
a) diluting the composition of claim 1 to produce a dilute solution;
b) applying the dilute solution to the surface; and
c) rinsing the dilute solution away from the surface, wherein the method is active against a micro-organism selected from the group consisting of bacterial, fungal, and viral organisms.

13. The method of claim 12, further comprising scrubbing the surface between steps b) and c).

14. The method of claim 12, further comprising allowing the dilute solution to remain on the surface for at least one minute prior to step c).

15. A method for reducing micro-organisms on surfaces used in animal care comprising the steps of
a) diluting the composition of claim 6 to produce a dilute solution;
b) applying the dilute solution to the surface; and
c) rinsing the dilute solution away from the surface;
wherein the micro-organisms are selected from the group consisting of bacterial, fungal, and viral organisms.

16. A method for removing odors from surfaces used by animals comprising the steps of
a) diluting the composition of claim 1 to produce a dilute solution;
b) applying the dilute solution to the surface; and
c) rinsing the dilute solution away from the surface.

17. A method for removing odors from surfaces used by animals comprising the steps of
a) diluting the composition of claim 6 to produce a dilute solution;
b) applying the dilute solution to the surface; and
c) rinsing the dilute solution away from the surface.

18. A method for disinfecting or reducing micro-organisms or insects on an animal comprising applying the shampoo of claim 10 to the animal, lathering, and rinsing the shampoo away from the animal.

19. (canceled)

20. An animal shampoo comprising 0.5 to 2 ounces of the composition of claim 6 per gallon of water.

21. A method for disinfecting or reducing micro-organisms or insects on an animal comprising applying the shampoo of claim 20 to the animal, lathering, and rinsing the shampoo away from the animal.

22. (canceled)
